(19) United States
(12) Patent Application Publication
(10) Pub. No.: US 2007/0100116 A1
(43) Pub. Date: May 3, 2007

(54) Low temperature processed resin for thermal and chemical protective coatings

(76) Inventor: Rafael J. Zaldivar, Huntington Beach, CA (US)

Correspondence Address: Carole A. Mulchinski;The Aerospace Corporation, 2350 East El Segundo Blvd, M1/040, El Segundo, CA, 90245, US

(21) Appl. No.: 11/264,055

(22) Filed: Nov. 1, 2005

(51) Int. Cl. C08G 8/02

(52) U.S. Cl. 528/128

(57) ABSTRACT

A resin coating is formulated for thermal and chemical resistant thin film applications, such as, barrier protection coatings for steel surfaces. The coating is an epoxy-modified novolac blend of pure novolac monomers and epoxy novolac monomers that are processed using a catalyst, such as hexamethylene-tetramine, and cured at low temperatures for providing coating coverage by optimizing a ratio of the pure novolac to the epoxy novolac. The ratio of epoxide novolac to pure novolac maximizes the cross-linking nature of the epoxide while taking advantage of the high thermal capability of the phenolic backbone. The resin formulation also incorporates an ideal concentration reactive carrier solvent that improves low temperature processability prior to curing and maximizes cross-linking for chemical and thermal protection while minimizing shrinkage after cure by cross-reacting within the polymer network.

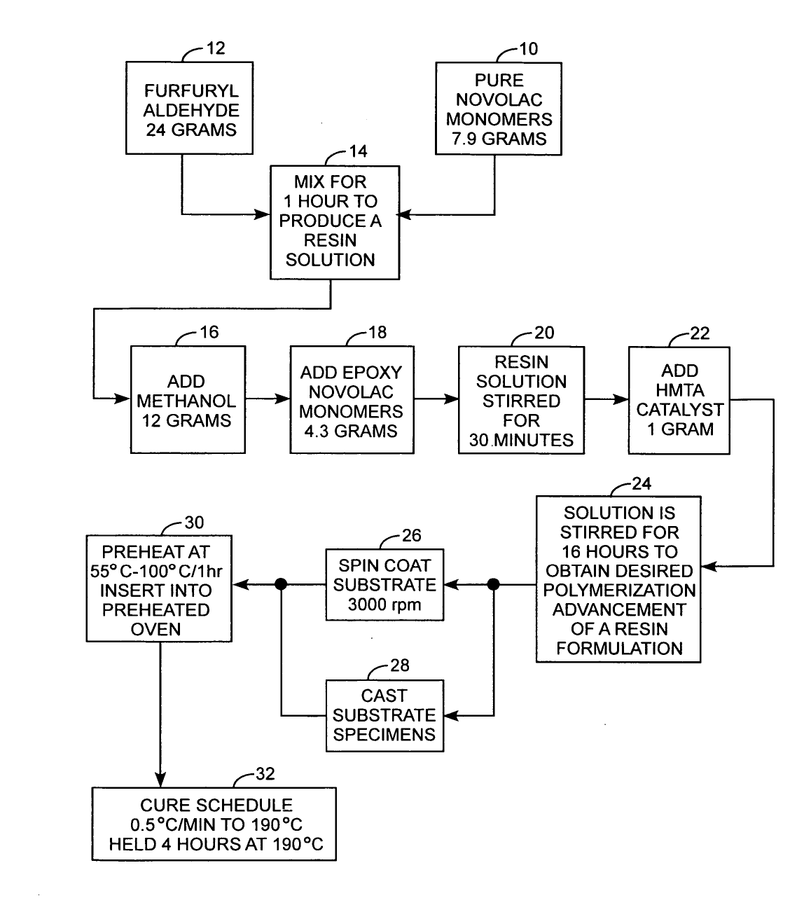

### FIELD OF THE INVENTION

The invention relates to the field of polymer protective coatings. More particularly, the invention relates to thermal and chemical resistant resin coating processed at low temperatures.

### BACKGROUND OF THE INVENTION

Phenolic resins are the primary candidates for coating applications requiring excellent thermal and chemical protective resistance. However, the phenolic family of resins typically has several drawbacks, which limits inherent use. Most polymer resins are susceptible to attack by either thermal or chemical attack. The degree of resistance is typically a function of resin chemical structure as well as the degree of cross-linking experienced by the structure. Typically, higher resistance is associated with very high temperature cure formulations. However, this negatively affects both costs as well as limits the types of substrates and surrounding components that can be used.

Phenolic resins contain polymers that require exceedingly high processing cure temperatures to achieve full cure. Cure temperatures in excess of 250° C. are necessary to achieve full cure. Full cure is essential to maximize cross-linking and thus provide the inherent mechanical resistant, thermal resistant, and chemical resistant properties of these polymers. The high cure temperatures also place limits on the substrates or components that can be coated without causing damage. These polymers also require long cure times at a temperature to achieve full cure. The thermal expansion of polymer coatings is high with a coefficient of thermal expansion between 75.0 and 95.0 micron/m/° C. range. Formulations of phenolic resin families have long cure times and high cure temperature necessary for full cure. The cure time can be greater than ten hours at temperature contributing to increased cost in manufacture. Long cure times greatly increases the cost associated with processing resins.

Phenolic monomers polymerize by condensation reactions so phenolic polymerization tends to be associated with large cure shrinkages. Typical cure shrinkage for a phenol formaldehyde resin is on the order of 30%. These large cure shrinkages cause interfacial stresses that can damage components being coated. Phenolic polymerization processes also tend to produce a large amount of volatiles during cure disadvantageously creating voids in the coating. Excessive void formation will deteriorate the resultant mechanical behavior of the coating. Phenolic resins also tend to be very brittle after curing making phenolic resin coatings susceptible to fracture and thus can greatly affect reliability of coated components.

Phenolic resins were the first commercially developed synthetic polymers. These thermosetting resins have wide industrial and commercial applications. Phenolic resins have been used in rocket nozzles and exit cones due to excellent low ablative and high thermal-structural properties. Phenolic resins have been used in binders used in the lamination industry. Phenolic resins are highly crosslinked structures providing excellent chemical resistance to most acids, bases, and solvents. In order to obtain many of these key properties, phenolic resins demand high temperature processing to ensure full cure.

Phenolic oligomers are prepared by reacting phenol and substituted phenols with formaldehyde or other aldehydes. Depending on the reaction conditions and the ratio of phenol to formaldehyde, two types of phenolic resins are obtained. Novolacs are derived from an excess of phenol under neutral to acidic conditions, while reactions under basic conditions using an excess of formaldehyde result in resoles. In this invention disclosure we will focus primarily on novolac resin formulations.

The primary polymerization reaction for phenolic resins is a condensation type reaction that basically eliminates both water and formaldehyde to form methylene linkage bridges. This methylene linkage formation is the primary mechanism for chain extension and cross-linking observed in the structure. Because phenolic monomers polymerize using a condensation type reaction, a significant amount of voids due to volatiles are typically observed. The type and concentration of the catalyst has been shown to be an important factor in minimizing the degree of volatile formation.

Curing of novolac resins requires the addition of cross-linking compounds. A catalyst hexamethylene-tetramine (HMTA) is typically used and has been the primary choice in base formulations for novolac resins used in high temperature coatings and films, and HMTA is unsuitable for curing of phenolic resins at low temperatures. Commercial phenolic novolac resins are commonly cured with HMTA, which yields networks with relatively high crosslink densities. Curing of pure novolac monomers with HMTA produces volatile by-products such as water, formaldehyde, and ammonia, which disadvantageously lead to voids in the materials. This has been a negative feature in phenolic matrix composites because the high void content leads to brittle components. Therefore, current commercial novolacs are limited to applications where high strength is not a requirement. On the other hand, the addition of an additive to the structure reduces shrinkage, volatile formation, and improves mechanical performance. Most epoxy resin have glass transition temperatures (Tg) in the 177° C. range and even polycyanurate resins seldom exceed 220° C. In addition, a secondary reactive solvent such as furfuryl alcohol or furfuryl aldehyde can be used to enhance wetting and toughen a brittle system.

A ratio of novolac monomers to epoxy novolac monomers has been adjusted for the desired flexibility. A high ratio has been used and results in increased coating flexibility. A low ratio has been used and results in increased coating brittleness. High temperature and long curing times provide for increased cross-linking and results in good chemical, thermal, and mechanical resistance. A catalyst triphenylphosphine has been added to the ratio of phenolic monomers to epoxy monomers. The use of the catalyst removes water for reducing voids and shrinkage in the coatings. In either case, high temperatures above 200° C. and long cure times greater than five hours are disadvantageously required. These and other disadvantages are solved or reduced using the invention.

### SUMMARY OF THE INVENTION

An object of the invention is to provide a method of making a protective coating made from pure novolac monomers and epoxy novolac monomers within a predetermined ratio.

Another object of the invention is to provide a method of making a protective coating made from pure phenolic monomers and epoxy novolac monomers, within a predetermined ratio, and a catalyst.

Yet another object of the invention is to provide a method of making a protective coating made from pure novolac monomers, and epoxy novolac monomers, within a predetermined ratio, and a hexamethylene-tetramine catalyst.

A further object of the invention is to provide a method of making a protective coating made from phenolic monomers, and an epoxy, within a predetermined medium ratio, and a hexamethylene-tetramine catalyst retained in resulting polymers.

A further object of the invention is to provide a method of making a protective coating made from phenolic novolac monomers, and an epoxy, within a predetermined medium ratio, and a hexamethylene-tetramine catalyst with the coating being cured at a low temperature and for a short amount of curing time.

The invention is directed to a method of making a resin for preferred use as coating. The resin system has been formulated for applications requiring high thermal and chemical resistant thin films such as but not limited to barrier protection coatings for steel containers. The coating is an epoxy novolac and pure novolac blend that provides excellent coverage and ease of processability. This formulation is obtained by optimizing the ratio between the phenolic monomers and the epoxide polymer ratio. The resin formulation uses a hexamethylene-tetramine (HMTA) catalyst during curing. The balanced ratio of epoxide monomers to phenolic monomers maximizes the cross-linking nature of the epoxide while taking advantage of the high thermal capability of the phenolic backbone. This formulation is processed at a relatively low temperature and short cure times and improves the chemical, thermal, and mechanical properties of the coating. The resin formulation is obtained by optimizing the ratio of pure novolac monomers to epoxy novolac monomers forming polymers in an HMTA cured system. The method incorporates a solvent that improves processability and coating by incorporating solvent within the polymer cross-linking network. The resin formulation also incorporates an ideal concentration of reactive carrier solvent that improves processability prior to cure and maximizes cross-linking and minimizes shrinkage after cure by cross-reacting within the network. These and other advantages will become more apparent from the following detailed description of the preferred embodiment.

### BRIEF DESCRIPTION OF THE DRAWING

The drawing is process flow for making a phenolic resin coating.

### DETAILED DESCRIPTION OF THE PREFERRED EMBODIMENT

An embodiment of the invention is described with reference to the drawing showing a process method of making a phenolic resin coating in steps 10 through 32.

In steps 10 and 12, a resin formulation is synthesized by adding 7.9 grams a resin of pure novolac monomers with 12.0 to 24.0 grams of furfuryl Aldehyde to form a resin solution. The pure novolac monomer resin is a phenolic resin. The pure novolac monomer resin includes all novolac monomers except epoxy novolac monomers.

In step 14, the resin solution is mixed 14 by stirring at room temperature for approximately one hour until the pure novolac monomers are completely dissolved in the furfuryl aldehyde. Furfuryl aldehyde is a reactive solvent.

In step 16, 12.0 grams of methanol are added to aid in the dissolution of the pure novolac monomers and the furfuryl aldehyde components.

In step 18, 4.3 grams of epoxy novolac monomers is then added to the resin solution. The epoxy novolac monomers are also phenolic monomers. The pure novolac monomers and the epoxy novolac monomers are available in both solid and liquid form.

In step 20, the resin solution is stirred for 30.0 minutes to dissolve the epoxy novolac monomers into the resin solution.

In step 22, and when all of the epoxy novolac monomers are dissolved, then 1.0 grams of hexamethylene-tetramine (HMTA) is added to the resin solution as a catalyst. The HMTA concentration is preferably between 0.25% to 1.0% in weight concentration in the resin solution. The catalyst can be any catalyst that reacts with pure novolac monomers, reacts with epoxy novolac monomers, and can be retained in the backbone of polymers derived from the pure and epoxide novolac monomers.

In step 24, the resin solution is then stirred for 16.0 hours at room temperature resulting in a resin formulation. The resin solution is stirred to a desired advancement of polymerization of the resin solution. During polymerization, the catalyst is retained in the polymer backbones.

In steps 26 and 28, the resin formulation can then be spun, dipped, cast, sprayed, or disposed onto a desired substrate. The coating is preferably cast by spin coating. A spinning wheel chuck can be used for spin coat deposition.

In step 30, and after the resin formulation has been cast onto the desired substrate, the coated substrate is preheated by inserting the coated substrate into a preheated oven for one hour at a preferred temperature between 55° C. and 110° C. The preheating is an initial bake stage.

In step 32, the coating is cured by a cure schedule. The cure schedule preferably uses a temperature ramp rate of less than 5° C./min, and is preferably less than 1° C./min, such as 0.5° C./min for heating the coating up to a temperature of less than 250° C., and preferably less than 200° C., such as 190° C. The resin formulation is held at the cure temperature for a predetermined amount of cure time, such as 4.0 hours, to allow the coating to be fully cured. The cure time should be less than twelve hours.

Fully cured well-consolidated polymer thin films can be achieved. The glass transition temperature (Tg) of the resin formulation is approximately 253-258° C. measured using a heat up rate of 5° C./minute. The resin formulation provides a high degradation thermal limit of greater than 300° C. The resin formulation provides a low coefficient of thermal expansion of less than 60.0 microns/m/° C., such as 56.0 microns/m/° C. The resin formulation provides low shrinkage during cure of less than 10%, such as 5.5%, while being cured at a relatively low temperature of less than 250° C., and preferably less than 200° C., such as 190° C. Cure shrinkage can be measured using helium pycnometry. The cure time at temperature necessary for full cure is low and less than twelve hours, such as four hours at the low cure temperature, contributing to cost savings of the manufacturing process. The resultant real density was measured at 1.288 g/cc. Variation in shrinkage can be controlled depending on variations of the furfuryl aldehyde concentration. However, limiting this concentration may affect mechanical properties. The thermal coefficient of expansion behavior is linear in nature. The furfuryl aldehyde concentration will affect the mechanical and chemical property of the resulting film and will have an affect upon the cure shrinkage of the film. The furfuryl aldehyde concentration will also affect the liquid-state pot-life of the resin formulation.

The HMTA cured phenolic resin formulation is optimized and results in a low temperature and low time cured resin with improved processability while retaining or improving the mechanical and chemical properties of phenolic resins. By the addition of a controlled amount of the epoxy novolac monomer component of the resin formulation, the mechanical and chemical properties can be adjusted. The ratio of pure novolac monomers to the epoxy novolac monomers has a strong influence on the resulting properties of the polymer network. The ratio between the pure novolac and the epoxide novolac is maximized for cross-linking at a weight ratio of 1.84:1 (7.9 grams/4.3). The ratio should be between 2:1 and 1.5:1, and preferably between 1.9:1 and 1.7:1. In addition, an optimized ratio of furfuryl aldehyde to pure and epoxide novolac weight ratio should be between 2:1 and 1:1, and is preferably 1.5:1, to aid in processability and the creation of void free films. The amount of furfuryl aldehydes can be optimized for the resin formulation to minimize shrinkage losses during cure.

Using a relative amount of 7.9 grams of pure novolac monomers, the furfuryl aldehyde is preferably between 12.0 and 24.0 grams, the methanol is 6.0 to 24 grams, the epoxy novolac monomers is 4.3 grams, and the HMTA catalyst is 0.5 to 1.0 grams. The weight ratio of the amount of pure novolac monomers divided by the amount of epoxy novolac monomers is preferably between 1.9 and 1.7

The invention is directed to a resin formulation made from a ratio of pure novolac monomers and epoxy novolac monomers in a predetermined ratio, and made with a catalyst that reacts with both monomers and is retained within polymers of the monomers. The resin formulation can be used for numerous coating applications requiring high thermal and chemical resistance. The resulting resin material can be used, for example, as coatings on containment articles such as barrels for chemical waste and or storage of strong acids, bases, and solvents. The resin material could also be used as a matrix material for composites requiring high thermal resistance. Those skilled in the art can make enhancements, improvements, and modifications to the invention, and these enhancements, improvements, and modifications may nonetheless fall within the spirit and scope of the following claims.

What is claimed is:

1. A method of making a resin material, the method comprising the steps of,
mixing pure novolac monomers with epoxy novolac monomers in a predetermined ratio for producing a resin solution,
mixing a catalyst with the resin solution for producing a resin formulation, and
curing the resin formulation into the resin material, the catalyst reacting with the pure novolac monomers and the epoxy novolac monomers, the catalyst being retain in a polymer formed from the pure novolac monomers and the epoxy novolac monomers.

2. The method of claim 1 wherein,
the catalyst is hexamethylene-tetramine (HTMA).

3. The method of claim 1 wherein,
curing step is at a predetermined curing temperature,
curing step is processed for a predetermined curing time.

4. The method of claim 1 wherein,
the curing temperature is less than 250° C.

5. The method of claim 1 further comprising the steps of,
mixing the pure novolac monomers with furfuryl aldehyde for dissolving the pure novolac monomers.

6. A method of making a resin material, the method comprising the steps of,
mixing pure novolac monomers with epoxy novolac monomers in a predetermined ratio for producing a resin solution,
mixing a catalyst with the resin solution for producing a resin formulation, hexamethylene-tetramine (HTMA), and
curing the resin formulation into the resin material, the catalyst reacting with the pure novolac monomers and the epoxy novolac monomers, the catalyst being retained in a polymer formed from the pure novolac monomers and the epoxy novolac monomers.

7. The method of claim 6 wherein,
the curing step is processed at a cure temperature of less than 200° C.

8. The method of claim 6 wherein,
the curing step is process at cure time of less than twelve hours.

9. The method of claim 6 wherein,
the ratio of pure novolac monomers to epoxy novolac monomers is between 1.5:1 and 2:1.

10. The method of claim 6 wherein,
the ratio of pure novolac monomers to epoxy novolac monomers is between 1.7:1 and 1.9:1.

11. The method of claim 6 further comprising the steps of,
mixing the pure novolac monomers with furfuryl aldehyde for dissolving the pure novolac monomers into a mixture, and
stirring the mixture,
mixing methanol into the mixture prior to mixing the epoxy novolac monomers, and
stirring the resin formulation.

12. The method of claim 6 further comprising the steps of,
mixing the pure novolac monomers with furfuryl aldehyde for dissolving the pure novolac monomers into a mixture, and
stirring the mixture,
mixing methanol into the mixture prior to mixing the epoxy novolac monomers into the resin formulation, and
stirring the resin formulation,
wherein,
the ratio of pure novolac monomers to epoxy novolac monomers is between 1.7:1 and 1.9:1,
the curing step is processed at 190° C. for four hours.

13. The method of claim 6 wherein,
the resin material has a coefficient of thermal expansion of less than 60.0 micron/m/° C.

14. The method of claim 6 wherein,
the resin material has a glass transition temperature of between 253° C. and 258° C.

15. The method of claim 6 wherein the curing step,
the resin material has a shrinkage rate of 5.5%, and

16. The method of claim 6 wherein,
the resin material has a density of 1.288 g/cc.

17. The method of claim 6 further comprising the step of,
depositing the resin material on a substrate prior to the curing step as a coating.

18. The method of claim 6 further comprising the step of,
depositing the resin material on a substrate for forming a matrix material.

19. The method of claim 6 further comprising the steps of,
mixing the pure novolac monomers with furfuryl aldehyde for dissolving the pure novolac monomers into a mixture, and
stirring the mixture,
mixing methanol into the mixture prior to mixing the epoxy novolac monomers into the resin formulation, and
stirring the resin formulation,
wherein,
the ratio of pure novolac monomers to epoxy novolac monomers is between 1.7:1 and 1.9:1,
the curing step is processed at 190° C. for four hours,
a relative amount of the pure novolac monomers is 7.9 grams,
a relative amount of the furfuryl aldehyde is between 12.0 and 24.0 grams,
a relative amount of the methanol is between 6.0 to 24 grams, and
a relative amount of the HMTA catalyst is between 0.5 to 1.0 grams.
